(19) United States
(12) Patent Application Publication
(10) Pub. No.: US 2010/0177604 A1
(43) Pub. Date: Jul. 15, 2010

(54) Combined Watch and Bands

(75) Inventor: Curtis Michael Ginter, Elgin, IL (US)

Correspondence Address: Curtis M. Ginter, 182 Neutrenton Ave, Elgin, IL, 60120, US

(73) Assignee: Curtis Michael Ginter, Elgin, IL (US)

(21) Appl. No.: 12/352,763

(22) Filed: Jan. 13, 2009

(51) Int. Cl. G04B 37/14

(52) U.S. Cl. 368/282

(57) ABSTRACT

A timekeeping device that is positioned on the back of the hand by securing said device to the wrist and to a finger or fingers. The bands used for securing said device are adjustable to accommodate different hand, wrist and finger sizes and to maximize comfort.

### BACKGROUND

1. Field of Invention

The present invention relates to an adjustable configuration for positioning a timekeeping device on the back of the hand.

2. Description of Related Art

Few attempts have been made to position a timepiece on the back of the hand. None allow for the user to adjust the bands to a comfortable length.

2. Prior Art

U.S. Pat. No. 2,926,825

U.S. Pat. No. 5,623,731

U.S. Pat. No. 5,779,113

U.S. Pat. No. 6,519,207

### SUMMARY

A method and watch that allows for adjustable positioning of a timekeeping device on the back of the hand. An adjustable band is provided extending laterally to the wrist area to secure the device to the wearer at the wearer's wrist. A second adjustable band is provided extending laterally away from the wrist to secure the watch body to one or more fingers, thereby adjustably securing the watch body to the back of the hand. The adjustable wristband and adjustable finger band allow for different size hands, wrists and fingers to be accommodated, thus maximizing comfort and fit for a wide variety of hand sizes and shapes.

### DESCRIPTION OF THE DRAWINGS

FIG. 1 is a top view illustration of a watch secured to a hand

FIG. 2 is a bottom view illustration of a watch secured to a hand

FIG. 3 is a top plan view of a watch

FIG. 4 is a rear plan view of a watch

FIG. 5 is a first partially exploded bottom view of a watch

FIG. 6 is a second partially exploded bottom view of a watch

FIG. 7 is an isometric view of a watch

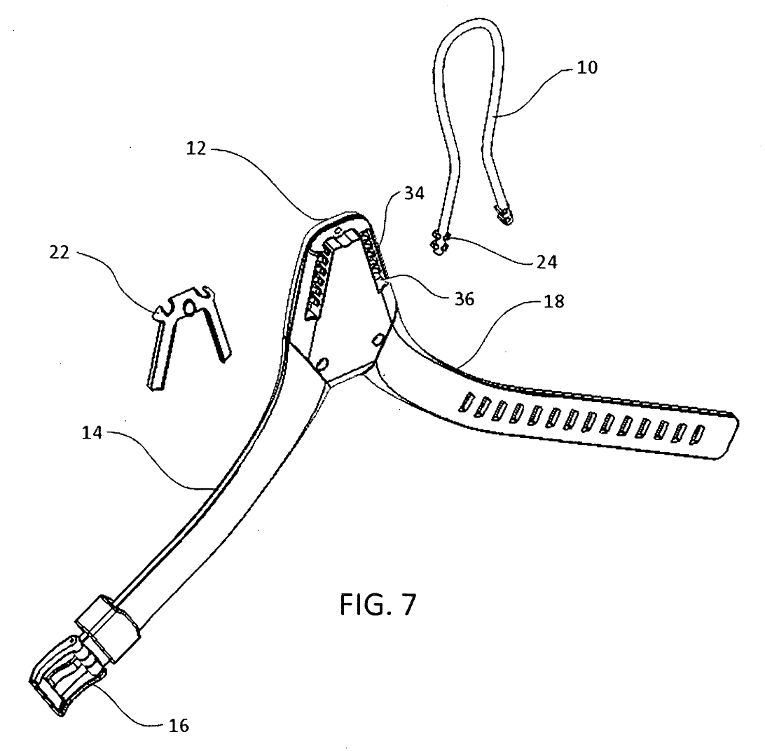

### DETAILED DESCRIPTION

The watch and its various parts can be made out of many different materials, including but not limited to: rubber, plastic, metal, leather, elastic, and others. The watch configuration allows the user to position a timekeeping device on the back of the hand and allows for adjustability of said device for position and comfort on a wide variety of hand sizes and shapes.

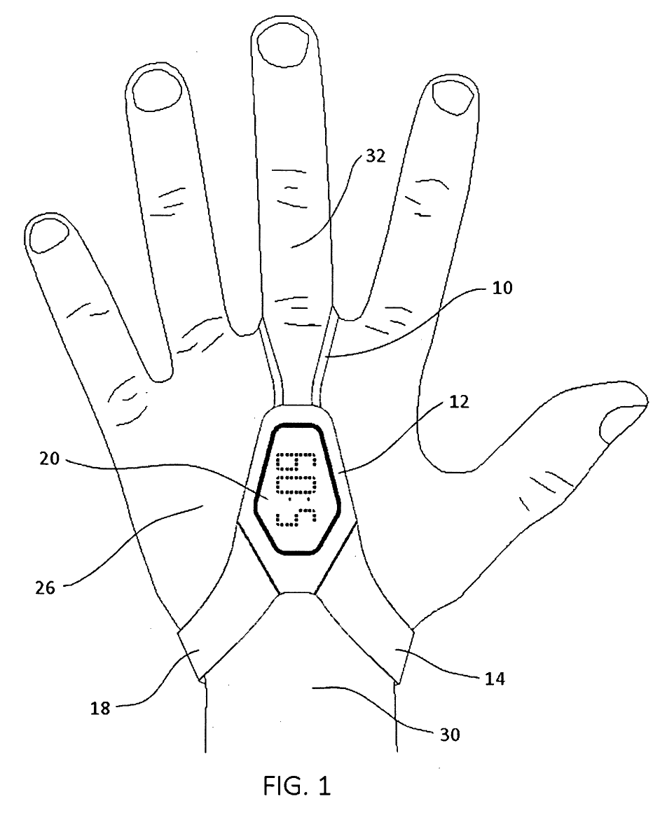

FIG. 1 illustrates one embodiment of the watch, showing how a timekeeping device can be adjustably positioned on the back of the hand. Comprised of two band systems, the finger band 10 and wrist bands 14, 18, the bands adjustably secure the watch body 12 to the back of the hand 26. The finger band 10 extends out laterally from the watch body 12 and loops around one or more of a wearer's fingers 32 to secure a first side of the watch body 12 to a wearer's hand. The finger band 10 forms a closed-path loop extending from the watch body 12. Although FIG. 1 shows only one finger band 10, more than one finger band may be provided. And while FIG. 1 shows the finger band 10 extending around a single finger 32, the band may alternatively extend around a plurality of wearers' fingers 32.

The wrist bands 14, 18 extend laterally out from the watch body 12 towards a wearer's wrist at a direction offset from a direction parallel to a wearer's arm and wrap around the wrist 30 to secure a second side of the watch body 12 to a wearer's hand.

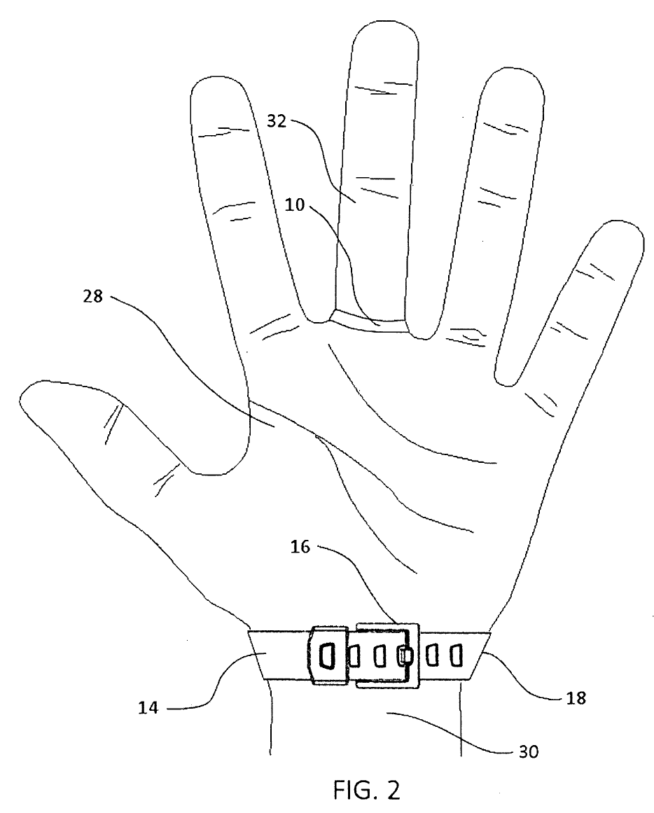

FIG. 2 illustrates a bottom view of the watch body 12 secured to a user's hand and further shows how the bands 10, 14, 18 secure the watch body 12 to the hand 28. The wrist bands 14,18 can be secured using any number of well known attachment methods. In the example set forth in FIG. 2, an adjustable buckle 16 was used.

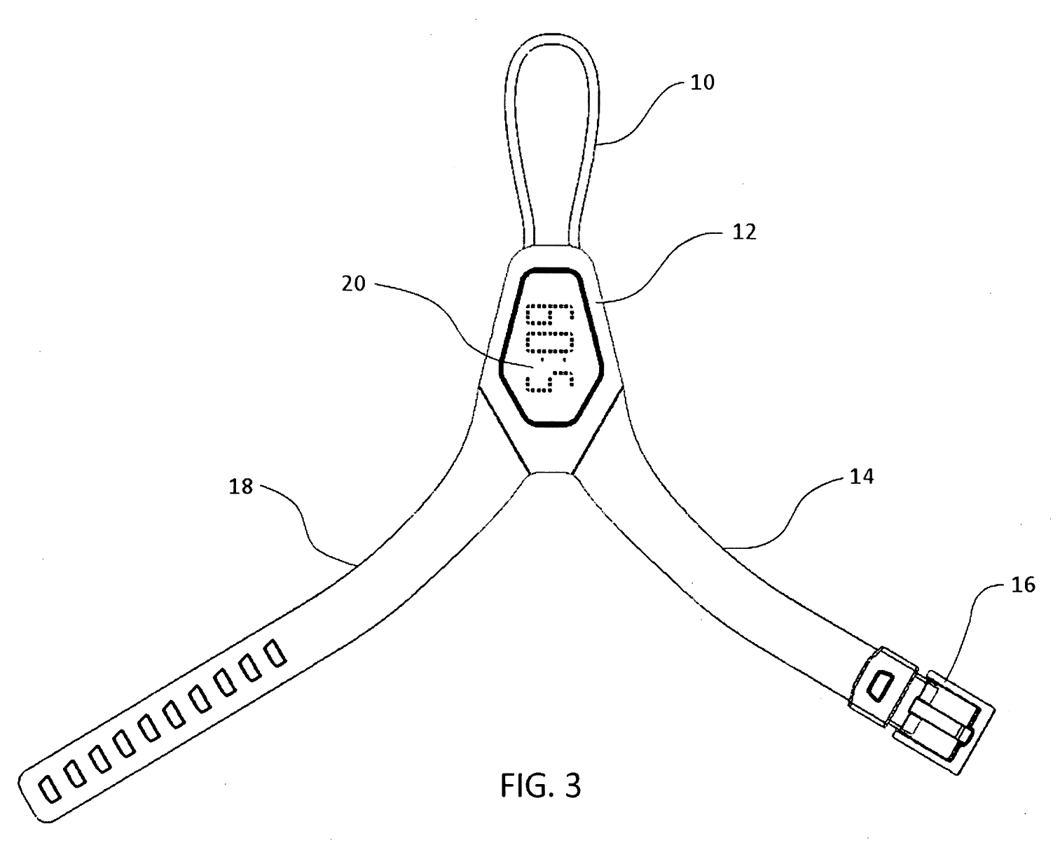

FIG. 3 illustrates a watch body 12 with a digital LCD display 20. The display can be shown in different ways, including digital, analog and others. The inner workings of the timepiece itself can be different types, including electrical and/or mechanical.

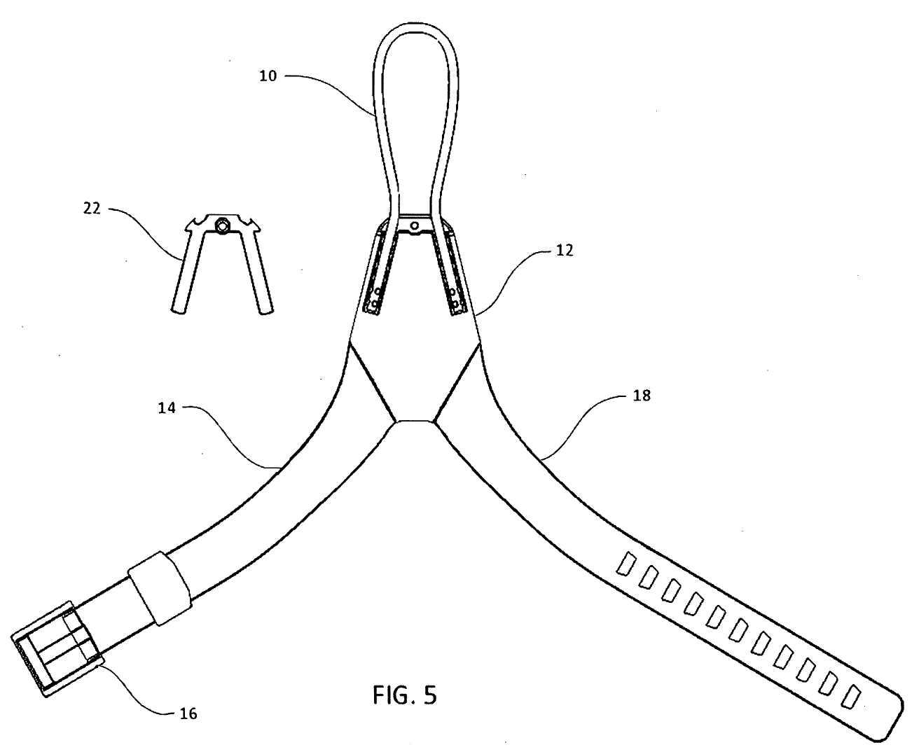

FIG. 5 shows the finger band cavity cover 22 removed. Allowing for adjustment, removal and/or replacement of the finger band 10.

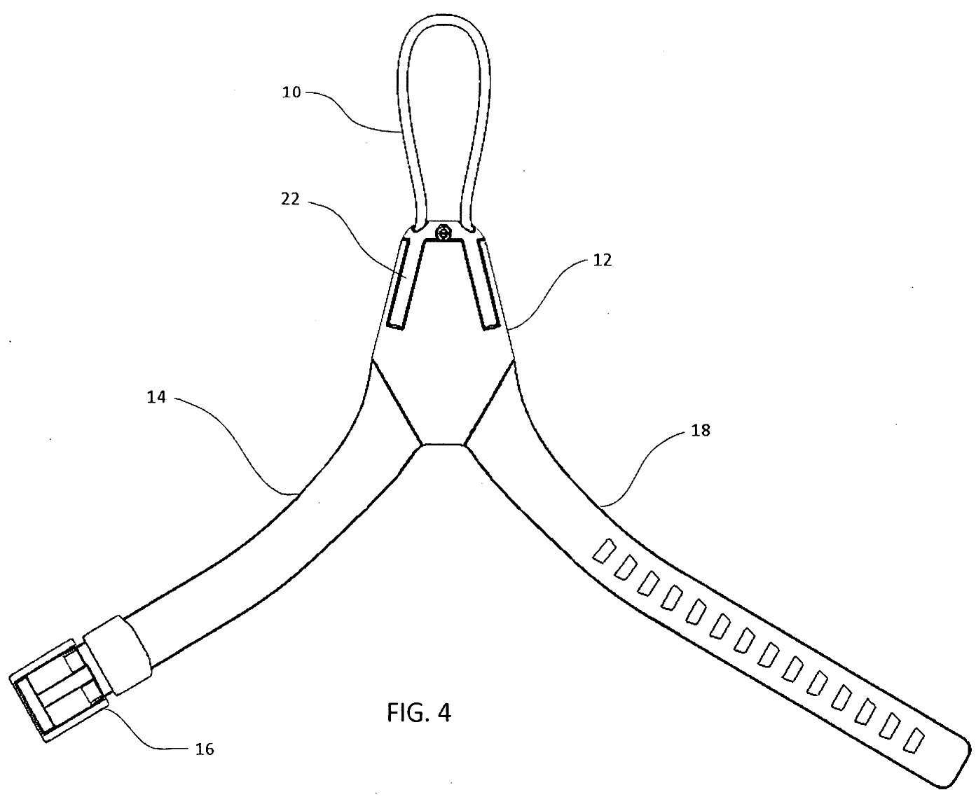

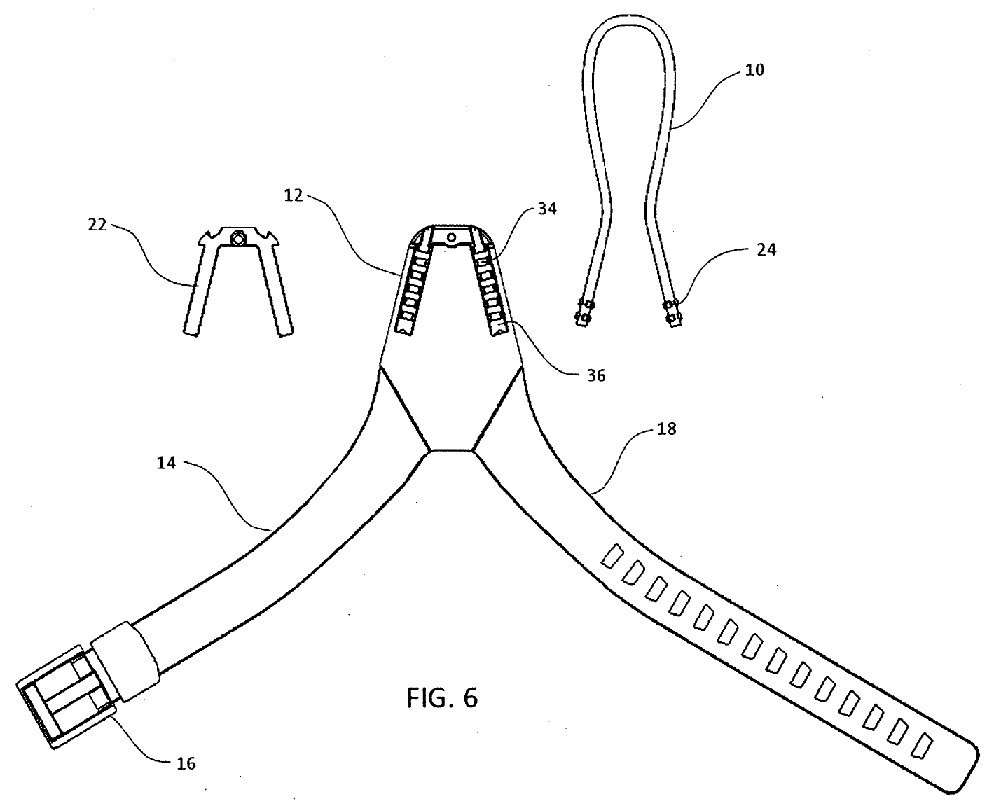

FIG. 6 shows a finger band 10 secured and adjusted using a system of cleats 24, 34. The cleats 24 on the band 10 are positioned securely between the cleats 34 of the watch body 12 inside the finger band cavity 36. The band 10 is held in place by a cover 22 which is fastened to the watch body 12 over the finger band cavity as shown in FIG. 4. The band 10 can be adjusted by moving the cleated end to different positions in the finger band cavity 36, thus allowing for the length of band 10 to be adjusted in relation to its overall length. The adjustability and securing of the finger band 10 can be attained in many different ways.

That which is claimed is:

1. A watch body and adjustable band system configured for positioning a timekeeping device on a wearer's hand, comprising:
a first band system configured to secure a watch body to a wearer's wrist,
a second band system configured to secure the watch body to a wearer's finger or fingers, said bands being adjustable.

2. The system as set forth in claim 1, wherein the band system is configured such that the watch body is substantially centered on the back of a wearer's hand.

3. A watch including a watch body and adjustable bands configured for positioning a timekeeping device on a wearer's hand, comprising:
a first closed loop band extending in a first direction from a watch body, and
second and third bands extending from an opposite side of the watch body.

4. The watch according to claim 3, wherein the first band extends in a substantially perpendicular direction from a first side of the watch body, and the second and third bands are angularly offset from a substantially perpendicular direction from a second side of the watch body.

5. The watch according to claim 4, wherein the second and third bands are angularly offset from the perpendicular direction a substantially equal amount.

6. The watch according to claim 3, wherein the second and third bands are configured to attach to one another.

7. A method of securing a watch to a hand comprising:
attaching a watch body to a wearer's finger with a close-loop path first band extending from a first side of the watch body; and attaching a watch body to a wearer's wrist with second and third bands extending from a second opposite side of the watch body.
